(19) United States
(12) Patent Application Publication
(10) Pub. No.: US 2003/0187842 A1
(43) Pub. Date: Oct. 2, 2003

(54) System and method for choosing a career

(76) Inventor: Carole Hyatt, New York, NY (US)

Correspondence Address: Philip M. Weiss, WEISS & WEISS, 500 OLD COUNTRY ROAD, GARDEN CITY, NY, 11530, US

(21) Appl. No.: 10/112,188

(22) Filed: Mar. 29, 2002

(51) Int. Cl. G06F 7/00

(52) U.S. Cl. 707/5

(57) ABSTRACT

The present invention is a system and method for choosing a career.

### FIELD OF THE INVENTION

The present invention relates to a system and method for choosing a career.

### BACKGROUND OF THE INVENTION

U.S. Pat. No. 5,164,687 relates to an automated method for selecting personnel matched to job criteria. The method includes the step of selecting a first set of employees having qualifications matching a first job criteria from a first data file where the first data file includes a first plurality of records, and each record includes a first job selection criteria, such as job titles, and a corresponding employee code. A second step comprises selecting a second plurality of employees having qualifications matching a second job criteria from a second data file which includes a second plurality of records wherein each record includes a second job selection criteria, such as industrial experience, and a corresponding employee code. In a further embodiment, a third selection is made from a third data file including records having a third job selection criteria, such as special skills, with a corresponding employee code. This results in three groups of selected records. The method requires selecting the records of those personnel whose employee codes occur at least once in each of the three employee sets.

U.S. Pat. No. 5,671,409 relates to a computer aided interactive career search system. The patent further relates to a method for accessing career information located in a computer database through interactive CD-ROM technology or other suitable computer-accessible means. The method involves the use of several levels of inquiry from which a user can select various careers, and for each career ask specific questions. The answers to these questions can be answered through digitized speech and video enactments of a person employed in a particular career field, or through text displayed on a computer screen. The textual material contained in the database can be printed through an attached printer.

U.S. Pat. No. 5,978,767 relates to a method and system for processing career development information. The system comprises a plurality of career development files. Each career development file is associated with at least one other career development file. The system includes a user interface system which receives a user selection of one of the career development files and displays the selected career development file. The system also includes a career library production system with which a curriculum designer can modify one or more of the career development files.

U.S. Pat. No. 5,978,768 relates to a computerized job search system and method for posting and searching job openings via a computer network. The patent relates to a method and apparatus for providing an interactive computer driven employment recruiting service. The system and method enables an employer to advertise available positions on the Internet, directly receive resumes from prospective candidates, and efficiently organize and screen the received resumes. Further, the system and method are capable of monitoring employment advertisements for a job seeker and automatically notifying the job seeker when a position for which the job seeker is suitable becomes available. The system enables a plurality of companies to advertise job positions at a single location accessible via the Internet by a job seeker, and enables the job seeker to communicate directly with a company via the Internet if the job seeker is interested in exploring further information pertaining to an available position at that company.

U.S. Pat. No. 6,049,776 relates to a human resource management system for staffing projects. A Resource Management System (RMS) including an RMS server having an RMS database containing files stores information on employees, employee skills, employee schedules and projects. The information in the files of the RMS database is obtained from external corporate databases as well as from direct entry. Calendar functionality is included for maintaining the scheduled activities of employees with different types of scheduled activities differently highlighted on a calendar display. Resource search and scheduling functionality is provided that identifies human resources possessing the required skills and availabilities for assignments to projects. Project parameters such as time requirements, skill requirements and proficiency levels are entered as parameters for defining the search. Assignment functionality assigns the identified employees to the projects and updates the system calendar to reflect the project assignments. RMS provides interfaces between the external databases and the RMS database for maintaining the information current that is stored therein. A common user interface provides a common view of the information in the RMS database and in the external databases. The RMS server, including the RMS database, is implemented on a programmed computer system.

U.S. Pat. No. 6,213,780 relates to a computer aided learning and counseling methods and apparatus for a job. The system can automatically identify learning objectives and provide learning materials for a user based on a job position identified for the user. The identification process depends on at least one attribute of the user's profile. After the job position is identified, the apparatus ascertains at least one learning objective for selecting learning materials to prepare the user for the job position. The user may be in the process of leaving a company, or may be graduating from a school.

U.S. Pat. No. 6,272,467 relates to an automated method for identifying matches between a set of predetermined traits and a set of preferences. This method can be used to find compatible matches in a variety of situations where participants are identified by a profile of traits and a set of criteria desired in a match, including, for example, matching candidates to residency program, and matching job hunters with employment opportunities. The invention provides an automated method for matching traits with corresponding preferences and insures only matches of the highest degree are made.

### SUMMARY OF THE INVENTION

The present invention relates to a system and method for determining future career possibilities. The system of the present invention is designed for a user who does not like their present job, or a high school or college graduate who has not decided on their future career. It is an object of the present invention to put users in touch with people who can help them attain their goals. The system of the present invention assists a user in answering the questions, What Comes Next, and Who Am I Going To Be Now. It is an object of the present invention to create a dream job for a user.

A user inputs or chooses from a directory the primary or hidden skills that the user enjoys exercising at work. These choices basically relate to the skills the user possesses. A user then inputs or chooses from a directory the passions or hobbies that the user enjoys. This relates to a job or a career. The system takes the users choices of skills that they possess and jobs that they desire and generates a career opportunity for the user. The system of the present invention contains a vast list of careers and in association with these careers is a list of the skills and hobbies that are associated with each career. The user then inputs or chooses from a directory the methodology and process they wish to pursue in doing this project. It is an object of the present invention to provide the user information on how to assist the user in fulfilling their new career opportunity. This can consist of a list of contacts for the user, literature, or other information. The system of the present invention can then save the information that it received to use to assist others who may want to network with the user based on their ideas.

A user can also input the title of their favorite job or position by either inputting the information into the system of the present invention or choosing from a directory. The system of the present invention can then produce the skills and hobbies that are associated with this job.

### DETAILED DESCRIPTION OF THE INVENTION

The system of the present invention contains a list of careers. With each career is a list of the skills and hobbies that are associated with that career. For instance if the career is a chef a hobby associated with that is cooking or preparing food. A skill associated with that is organization of large events, works well with their hands, etc. If a user were to enter these skills and/or hobbies into the system of the present invention, one of the careers that would be produced to the user would be a chef. The system also contains information for the user on how to achieve their objective, such as in the above case, a list of culinary schools.

A user inputs into the system of the present invention or chooses from a directory the title of their favorite job or position and selects the primary or hidden skills that a user enjoys exercising at work. For example a user can enter that the skills as INNOVATIVE DESIGN. The user then chooses from a directory or inputs into the system what represents their passion or hobby. For example a user can choose WALKING. The system of the present invention based on the information produces a list of new carrer opportunities for a person who has inputted INNOVATIVE DESIGN as their skills and WALKING as their hobby. One such result produced from the system is DESIGN A WALKATHON CAMPAIGN. In a preferred embodiment, the system requests from the user information on how the user would like to implement this plan. The user for example can input that they wish to be a CONSULTANT. The system of the present invention can then present for the user contacts for the user, literature, etc. For example, the system of the present invention can provide the Internet addresses for the Cancer Walkathon coordinator, a person who designs web sites for special events, a celebrity who is active in causes, and the coordinator for the March of Dimes.

In a preferred embodiment, the system of the present invention searches the database of the present invention to find other users who have similar interests and provides their contact information to the user.

In a second example a user inputs for skills Scientific Researcher for Skills and Writing for the Hobby. The system of the present invention produces a list of potential career opportunities including, patent agent or patent attorney. The user inputs that they would like to be a patent attorney. The system of the present invention produces a list of law schools which offer courses in patent law.

In a further example a user inputs that their hobby is EXERCISE, and that their skills are TEACHING. The system of the present invention produces a list of possible career choices, including personal trainer. The user inputs that they wish to become a personal trainer, and the system of the present invention produces a list of certifications that are required and how to obtain them.

What is claimed is:

1. A method for determining future career possibilities comprising;.
computing into a system or choosing from a directory skills that a user possesses;
inputting into said system or choosing from said directory passions or hobbies that a user enjoys;
producing to said user a list of career opportunities based on said user's skills and hobbies.

2. The method of claim 1 further comprising;
inputting into said system or choosing from a directory methodology and process said user wishes to pursue in attaining said career opportunity

3. The method of claim 1 further comprising;
providing said user information on how to fulfill said career opportunity.

4. The method of claim 3 wherein said information comprises a list of contacts for said user, literature, or other related information.

5. The method of claim 1 further comprising;
inputting into said system contact information about said user and said career opportunity of said user.

6. The method of claim 1 further comprising;
providing information to said user concerning other users who have similar career opportunities.

7. A system for determining future career possibilities comprising;
a database comprising a list of careers;
each of said careers having a list of the skills and hobbies that are associated with it.

8. The system of claim 7 further comprising;
a database comprising literature, contacts or other information about entering said career.

9. A method for determining future career possibilities comprising;
inputting into a system or choosing from a directory a title of a user's favorite job or position;
producing skills and hobbies that are associated with said job.
